(19) United States
(12) Patent Application Publication
(10) Pub. No.: US 2006/0061800 A1
(43) Pub. Date: Mar. 23, 2006

(54) SERVICE SYSTEM FOR PRINTING DATA OF A MESSAGE AND METHOD THEREOF

(76) Inventor: Chih-Hung Kao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,055

(22) Filed: Mar. 18, 2005

(30) Foreign Application Priority Data
Sep. 23, 2004 (TW) 093128884

(51) Int. Cl. G06F 3/12

(52) U.S. Cl. 358/1.15

(57) ABSTRACT

A service system for printing data of a message includes a message transceiver for receiving a message transmitted from a message sending terminal, a data collecting server for processing data of the message according to parameters of the message received by the message transceiver, a print module for printing data generated by the data collecting server, and a transmitting mechanism for transmitting data printed out by the print module to a destination corresponding to an address index provided by the message received by the message transceiver.

### BACKGROUND OF INVENTION

1. Field of the Invention

The present invention relates to a service system for printing data of a message and method thereof, and more particularly, to a service system for printing data of a message transmitted from a message sending terminal and for transmitting the printed-out data to a destination and method thereof.

2. Description of the Prior Art

The mobile phone has developed very rapidly for the past several years. New mobile phones are equipped with more refined functions. Many mobile phones can transmit images by downloading or sending messages and may also have a photo function. The conventional method for printing images stored in the mobile phone is to transmit the images received through the network, images received through messages, or photos taken with the mobile phone to a personal computer, and then to utilize the personal computer to control a printer for printing the images. The other way is to transmit images from the mobile phone to a printer through a wired connection or through wireless communication technology, such as the Bluetooth wireless network protocol or infrared technology, for printing out the images. However not every user has a photo printer, such as a thermal photo printer, for printing out images with photo quality. Hence it is inconvenient for common users that images captured by the mobile phone cannot be printed out.

### SUMMARY OF THE INVENTION

It is therefore a primary objective of the claimed invention to provide a service system for printing data of a message and method thereof for solving the above-mentioned problem.

According to claimed invention, a service system for printing data of a message includes a message transceiver for receiving a message transmitted from a message sending terminal, a data collecting server for processing data of the message according to parameters of the message received by the message transceiver, a print module for printing data generated by the data collecting server, and a transmitting mechanism for transmitting data printed out by the print module to a destination corresponding to an address index provided by the message received by the message transceiver.

According to claimed invention, a method for printing data of a message includes the following steps: (a) receiving a message transmitted from a message sending terminal; (b) processing data of the message according to parameters of the message; (c) printing the data generated in Step (b); and (d) transmitting data printed out in Step (c) to a destination corresponding to an address index provided by the message.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a service system of the present invention.

FIG. 2 is a flowchart illustrating the service system in FIG. 1 of the present invention receiving the message from a message sending terminal and transmitting printed-out data of the message to a destination.

FIG. 3 is a diagram of the data generated by a data collecting server.

### DETAILED DESCRIPTION

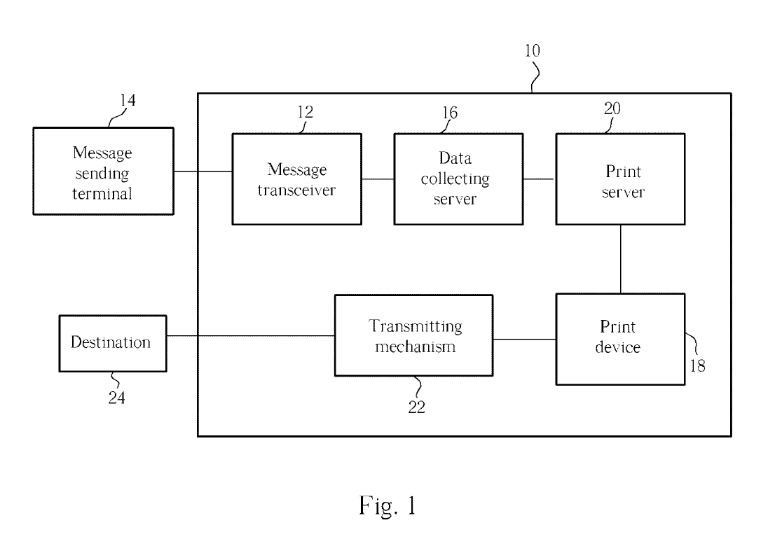

Please refer to FIG. 1. FIG. 1 is a functional block diagram of a service system 10 of the present invention. The service system 10 can be a cooperative system of both a telecom business and a printing business. The service system 10 includes a message transceiver 12 for receiving a message transmitted from a message sending terminal 14. The message transceiver 12 can include a phone number or a uniform resource locator (URL) for serving as a destination for receiving the message from the message sending terminal 14. The service system 10 further includes a data collecting server 16 for processing data of the message according to parameters of the message received by the message transceiver 12, a print device 18 which can be a thermal printer, a print server 20 electrically connected to the print device 18 for receiving data generated by the data collecting server 16 and controlling the print device 18 to print the data generated by the data collecting server 16, and a transmitting mechanism 22 for transmitting data printed out by the print device 18 to a destination 24 corresponding to an address index provided by the message received by the message transceiver 12. The transmitting mechanism 22 can be a postal mechanism, such as a publicly-owned postal service, a private postal service, an express delivery service, or other goods traffic services.

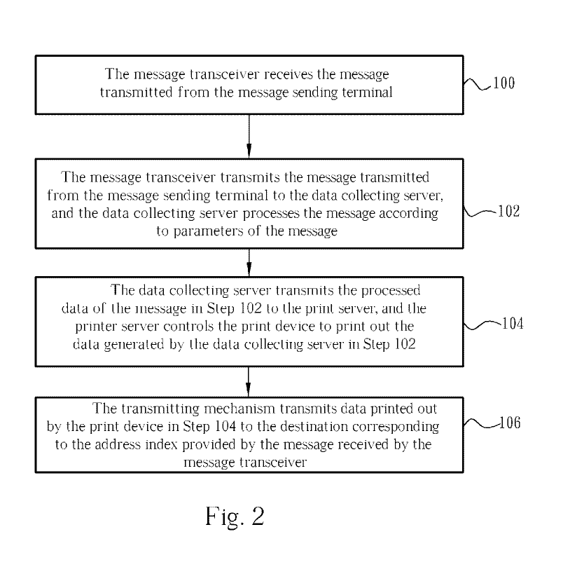

Please refer to FIG. 2. FIG. 2 is a flowchart illustrating the service system 10 of the present invention receiving the message from the message sending terminal 14 and transmitting printed-out data of the message to the destination 24. The method includes the following steps:

Step 100: The message transceiver 12 receives the message transmitted from the message sending terminal 14.

Step 102: The message transceiver 12 transmits the message transmitted from the message sending terminal 14 to the data collecting server 16, and the data collecting server 16 processes the message according to parameters of the message.

Step 104: The data collecting server 16 transmits the processed data of the message in Step 102 to the print server 20, and the printer server 20 controls the print device 18 to print out the data generated by the data collecting server in Step 102.

Step 106: The transmitting mechanism 22 transmits data printed out by the print device 18 in Step 104 to the destination 24 corresponding to the address index provided by the message received by the message transceiver 12.

The detailed description of the above-mentioned steps is introduced as follows. First a user can send the message from the message sending terminal 14 to the message transceiver 12. The message sending terminal 14 can be a mobile phone or a network node, such as a website of a telecom business, and the message can be a Multimedia Messaging Service (MMS) message containing attached words and images, wherein the words of the message can be input by the mobile phone or by the website of the telecom business and the images of the message can be input from the network, from received messages, from photos taken by the mobile phone, or from the website of the telecom business. The user can transmit the message from the message sending terminal 14 to the message transceiver 12. The message transceiver 12 can include a phone number or a uniform resource locator (URL) for serving as a destination for receiving the message from the message sending terminal 14.

After the message transceiver 12 receives the message, the message transceiver 12 transmits the message to the data collecting server 16. First the data collecting server 16 checks the content of the message to confirm whether image files and information of an addressee are attached to the message. If the content of the message is wrong, such as image files not being attached to the message, the data collecting server 16 can control the message transceiver 12 to reply with an error message to the message sending terminal 14 for informing the message sending terminal 14 that the message is wrong and that the message sending terminal 14 should send another message again. If the content of the message is correct but information of the addressee is not attached to the message, wherein the information of the addressee can be an address of the addressee or a phone number of the same telecom business as the message sending terminal 14, the data collecting server 16 can control the message transceiver 12 to reply with an acknowledge message to the message sending terminal 14 to inform the message sending terminal 14 that the content of the message is correct and the information of the addresser is attached but the information of the addressee is not attached. If the content of the message is correct and the information of the addressee is attached to the message, wherein the information of the addressee can be an address of the addressee or a phone number of the same telecom business as the message sending terminal 14, the data collecting server 16 can control the message transceiver 12 to reply with an acknowledge message to the message sending terminal 14 to inform the message sending terminal 14 that the content of the message is correct and the information of the addresser and the addressee is attached.

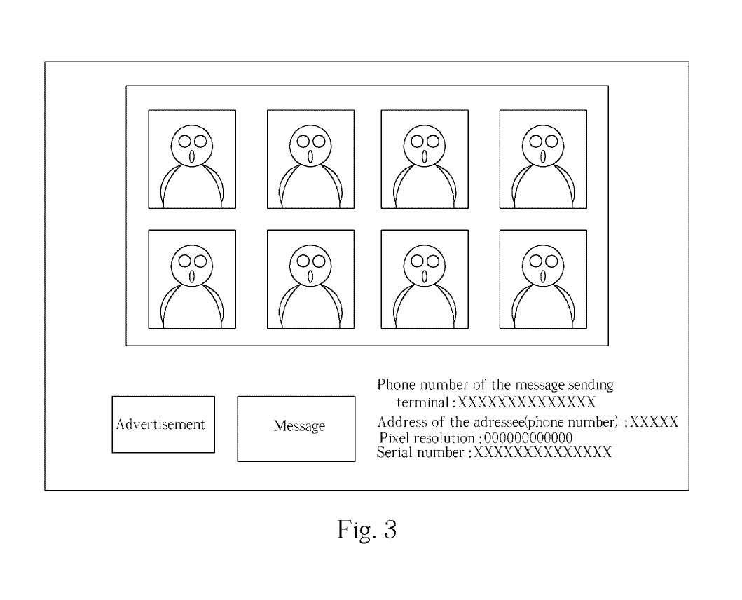

The data collecting server 16 can process the message according to parameters of the message. Please refer to FIG. 3. FIG. 3 is a diagram of the data generated by the data collecting server 16. The data includes the images and words that the addresser of the message sending terminal 14 asks the service system 10 to print out. The images can be presented as portraits, and the words can present the information the addresser of the message sending terminal 14 leaves to the addressee. The data can further include an advertisement of the telecom business or other brands, and the related information of the printed-out message, such as the phone number of the message sending terminal 14, the address or the phone number of the addressee, the pixel resolution of the printed-out image, and the serial number of the printed-out message. In addition, the data shown in FIG. 3 can be stored in a network server and displayed on the website of the telecom business, so the addresser of the message sending terminal 14 can preview it on the website to confirm the processed data of the message. Further the addresser of the message sending terminal 14 can choose the frame or background on the website for decorating the printed-out message.

After the data collecting server 16 transmits the processed data to the print server 20, the print server 20 schedules the received data according to the print media and then sends the data to the print device 18 coupled to the print server 20 to print out the data shown in FIG. 3. The print device 18 can include a plurality of thermal printers, so the proper print device 18 can be arranged by the print server 16 to allot proper printing resources for printing out the data. The print device 18 can print the data on all kinds of print media.

The transmitting mechanism 22 can transmit data printed out by the print device 18 to the destination 24 corresponding to the address index provided by the message received by the message transceiver 12. For example, if the message includes the address of the addressee, the address index is the address of the addressee and the transmitting mechanism 22 will transmit the printed-out message to the address of the addressee. The transmitting mechanism 22 can be a postal mechanism, such as a publicly-owned postal service, a private postal service, an express delivery service, or other goods traffic services, for mailing the data printed out by the print device 18 to the address of the addressee. If the message includes the phone number of the mobile phone of the addressee, the telecom business can obtain the billing address of the addressee according to the phone number of the addressee. In this case, the address index is the billing address of the addressee, and the transmitting mechanism 22 will transmit the printed-out message to the billing address of the addressee. If the message does not include the address or the phone number of the mobile phone of the addressee, the address index is the billing address of the addresser of the message sending terminal 14, such as the billing address of the phone number of the message sending terminal 14, and the transmitting mechanism 22 will transmit the printed-out message to the billing address of the addresser of the message sending terminal 14. This is because the message does not include any information of the addressee, and the printed-out data will be transmitted back to the message sending terminal 14.

In addition, the telecom business can calculate the number of times the service system 10 has been utilized during a time period according to statistics compiled by the data collecting server 16 for calculating the service fee for the service system 10, and the telecom business can then send a bill to the billing address of the message sending terminal 14.

In contrast to the prior art, the service system and method thereof can solve the problem in which images captured by the mobile phone cannot be printed out with a proper printer. The image data printed out by the service system can not only be mailed back to the original addresser but also be mailed to other friends to share the cordial atmosphere. The present invention can improve the convenience of the photo function of mobile phones and can provide a new business model in which telecom businesses can provide users with an extra service.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A service system for printing data of a message comprising:
a message transceiver for receiving a message transmitted from a message sending terminal;
a data collecting server for processing data of the message according to parameters of the message received by the message transceiver;
a print module for printing data generated by the data collecting server; and
a transmitting mechanism for transmitting data printed out by the print module to a destination corresponding to an address index provided by the message received by the message transceiver.

2. The service system of claim 1 wherein the message transceiver comprises a phone number serving as a destination for receiving the message from the message sending terminal.

3. The service system of claim 1 wherein the message transceiver comprises a uniform resource locator (URL) serving as a destination for receiving the message from the message sending terminal.

4. The service system of claim 1 wherein the message sending terminal is a mobile phone.

5. The service system of claim 1 wherein the message sending terminal is a network node.

6. The service system of claim 1 wherein the data collecting server is capable of displaying data of the message on a website.

7. The service system of claim 1 wherein the print module comprises a print device and a print server electrically connected to the print device for receiving data generated by the data collecting server and controlling the print device to print the data generated by the data collecting server.

8. The service system of claim 7 wherein the print device is a thermal printer.

9. The service system of claim 1 wherein the transmitting mechanism is a postal mechanism.

10. The service system of claim 1 wherein the transmitting mechanism is utilized for mailing data printed out by the print module to an address of an addressee provided by the message received by the message transceiver.

11. The service system of claim 1 wherein the transmitting mechanism is utilized for mailing data printed out by the print module to a billing address of the message sending terminal.

12. The service system of claim 1 wherein the data collecting server is capable of controlling the message transceiver to reply with an acknowledge message to the message sending terminal according to whether the message received by the message transceiver is correct or not.

13. The service system of claim 1 wherein the message includes an image.

14. A method for printing data of a message comprising:
(a) receiving a message transmitted from a message sending terminal;
(b) processing data of the message according to parameters of the message;
(c) printing the data generated in Step (b); and
(d) transmitting data printed out in Step (c) to a destination corresponding to an address index provided by the message.

15. The method of claim 14 wherein the message sending terminal sends the message to a phone number.

16. The method of claim 14 wherein the message sending terminal sends the message to a uniform resource locator (URL).

17. The method of claim 14 wherein the message sending terminal is a mobile phone.

18. The method of claim 14 wherein the message sending terminal is a network node.

19. The method of claim 14 wherein Step (b) further comprises storing the data of the message on a network server and displaying the data of the message on a website.

20. The method of claim 14 wherein Step (c) comprises utilizing a thermal printer to print the data generated in Step (b).

21. The method of claim 14 wherein Step (d) comprises mailing data printed out in Step (c) to an address of an addressee provided by the message.

22. The method of claim 14 wherein Step (d) comprises mailing data printed out in Step (c) to a billing address of the message sending terminal.

23. The method of claim 14 further comprising replying an acknowledge message to the message sending terminal according to whether the message transmitted from the message sending terminal is correct or not.

24. The method of claim 14 wherein the message comprises an image.
